(19) United States
(12) Patent Application Publication
(10) Pub. No.: US 2013/0038084 A1
(43) Pub. Date: Feb. 14, 2013

(54) CONVERTIBLE TOP

(71) Applicant: Markus Scholten, Newport Beach, CA (US)

(72) Inventors: Matti Kinnanen, Laitila (FI); Olli Hyytia, Uusikaupunki (FI); Veijo Mattila, Uusikaupunki (FI); Juha Varjonen, Uusikaupunki (FI); Markus Scholten, Newport Beach, CA (US)

(73) Assignee: FISKER AUTOMOTIVE, INC., Irvine, CA (US)

(21) Appl. No.: 13/143,534

(22) PCT Filed: Jan. 8, 2010
(86) PCT No.: PCT/US2010/020502

§ 371 Date: Feb. 27, 2012

Related U.S. Application Data
(60) Provisional application No. 61/143,200, filed on Jan. 8, 2009.

(51) Int. Cl. B60J 7/14

(52) U.S. Cl. 296/107.17

(57) ABSTRACT

The convertible top assembly includes a front panel member and a rear panel member. The convertible top assembly also includes a main pivot bracket attached to the vehicle. The main pivot bracket includes a forwardly located arm pivotally connected to a rear edge of the front panel member and a rearwardly located arm pivotally attached to a rear edge of the rear panel member, such that an inner surface of the front panel member is adjacent an outer surface of the rear panel member when the convertible top is in a retracted position. To retract the convertible top, the deck lid pivots on a rearward edge along a first pivot axis while a rear edge of the rear panel pivots upwardly about a third pivot axis.

### CROSS REFERENCE TO RELATED APPLICATIONS

This application claims the benefit of and priority to U.S. Provisional Application No. 61/143,200, filed Jan. 8, 2009, which is incorporated herein by reference.

### BACKGROUND

The present disclosure relates generally to a convertible top for a vehicle, and more particularly to convertible top assembly for a convertible vehicle.

### DESCRIPTION OF THE RELATED ART

Vehicles with a convertible top include a roof portion that is moveable between an extended position covering the interior of the vehicle, and a retracted position whereby the interior or passenger compartment of the vehicle is exposed. In an extended position, a front portion of the convertible top is aligned and locked to an adjacent header portion of a windshield, in a retracted position, the roof is disposed within a storage space, typically located behind the passenger compartment. In this example, the convertible top storage space is within the trunk compartment of the vehicle.

While conventional convertible tops work well, it is desirable to provide a convertible top that is compact when folded, operates more efficiently, is easier to assembly and less expensive to produce. Thus, there is a need in the art for a convertible top assembly that is accessible to the vehicle operator, and quickly moves between the extended and retracted positions.

### SUMMARY

Accordingly, the present disclosure relates to a convertible top assembly. The convertible top assembly includes a front panel member and a rear panel member. The convertible top assembly also includes a main pivot bracket attached to the vehicle. The main pivot bracket includes a forwardly located arm pivotally connected to a rear edge of the front panel member and a rearwardly located arm pivotally attached to a rear edge of the rear panel member, such that an inner surface of the front panel member is adjacent an outer surface of the rear panel member when the convertible top is in a retracted position. To retract the convertible top, the deck lid pivots on a rearward edge along a first pivot axis while a rear edge of the rear panel pivots upwardly about a third pivot axis. At a predetermined time, the front panel pivots rearwardly along an arc and the tonneau cover pivots upwardly about a front edge so that the front panel passes underneath the rear panel and is stowed in the storage compartment, the rear panel closes on top of the front panel, the tonneau closes and the deck lid closes and is latched.

An advantage of the present disclosure is that a convertible top assembly is provided that quickly moves between extended and retracted positions. Another advantage of the present invention is that the convertible top assembly is readily packagable into the trunk of the vehicle. A further advantage of the present invention is that the convertible top assembly is cost effective to implement.

Other features and advantages of the present disclosure will be readily appreciated, as the same becomes better understood after reading the subsequent description taken in conjunction with the accompanying drawings,

### BRIEF DESCRIPTION OF THE DRAWINGS

FIG. 1 is a perspective view of a vehicle having a convertible top.

FIG. 2 is an elevational side view of the convertible top assembly for the convertible vehicle of FIG. 1.

FIG. 3 is an devotional side view of the convertible top assembly of FIG. 2 illustrating nominal opening of the deck lid.

FIG. 4 another elevational side view of the convertible top assembly of FIG. 2.

FIG. 5 is an devotional side view of the convertible top assembly of FIG. 2 illustrating opening of the deck lid to retract the convertible top assembly.

FIG. 6 is an elevational side view of the convertible top assembly of FIG. 2 illustrating opening of the rear panel to retract the convertible top assembly.

FIG. 7 is an elevational side view of the convertible top assembly of FIG. 2 illustrating opening of the deck lid and rear panel at mid cycle to retract the convertible top assembly.

FIG. 8 is an elevational side view of the convertible top assembly of FIG. 2 illustrating opening of the front panel to retract the convertible top assembly.

FIG. 9 is an elevational side view of the convertible top assembly of FIG. 2 illustrating opening of the tonneau cover to retract the convertible top assembly.

FIG. 10 is an elevational side view of the convertible top assembly of FIG. 2 illustrating storage of the front panel to retract the convertible top assembly.

FIG. 11 is an elevational side view of the convertible top assembly of FIG. 2 illustrating storage of the rear panel and deck lid to retract the convertible top assembly.

FIG. 12 is an elevational side view of the convertible top assembly of FIG. 2 illustrating closing of the tonneau cover to retract the convertible top assembly.

FIG. 13 is an devotional side view of the convertible top assembly of FIG. 2 in a retracted position.

FIGS. 14-20 are side views of the convertible top assembly of FIG. 2 illustrating operation of the main pivot bracket.

FIG. 21 is an devotional side view of the convertible top assembly for the convertible vehicle of FIG. 1, according to an exemplary embodiment.

FIG. 22 is an elevational perspective view of the convertible top assembly of FIG. 21.

FIG. 23 is a partial enlarged view of the main pivot bracket of the convertible top assembly of FIG. 21.

FIG. 24 is another elevational side view of the convertible top assembly of FIG. 21 illustrating nominal opening of the deck lid.

FIG. 25 is an devotional side view of the convertible top assembly of FIG. 21 illustrating opening of the rear panel to retract the convertible top assembly.

FIG. 26 is an elevational side view of the convertible top assembly of FIG. 21 illustrating the positioning of the rear panel adjacent the front panel to retract the convertible top assembly.

FIG. 27 is an elevational side view of the convertible top assembly of FIG. 21 illustrating the opening of the deck lid to retract the convertible top assembly.

FIG. 28 is an elevational side view of the convertible top assembly of FIG. 21 illustrating the complete opening of the deck lid to retract the convertible top assembly.

FIG. 29 is an elevational side view of the convertible top assembly of FIG. 21 illustrating the opening of the front panel to retract the convertible top assembly.

FIG. 30 is an elevational side view of the convertible top assembly of FIG. 21 illustrating the further opening of the front panel to retract the convertible top assembly.

FIG. 31 is an elevational side view of the convertible top assembly of FIG. 21 illustrating the storage the front and rear panel to retract the convertible top assembly.

FIG. 32 is an elevational side view of the convertible top assembly of FIG. 21 illustrating the storage of the front and rear panel and the deck lid closed.

FIG. 33 is an elevational side view of the convertible top assembly of FIG. 21 illustrating the storage of the convertible top assembly and opening of the deck lid to access the storage area of the vehicle.

FIG. 34-44 are side views of the convertible top assembly of FIG. 21 illustrating operation of the main pivot bracket.

### DESCRIPTION

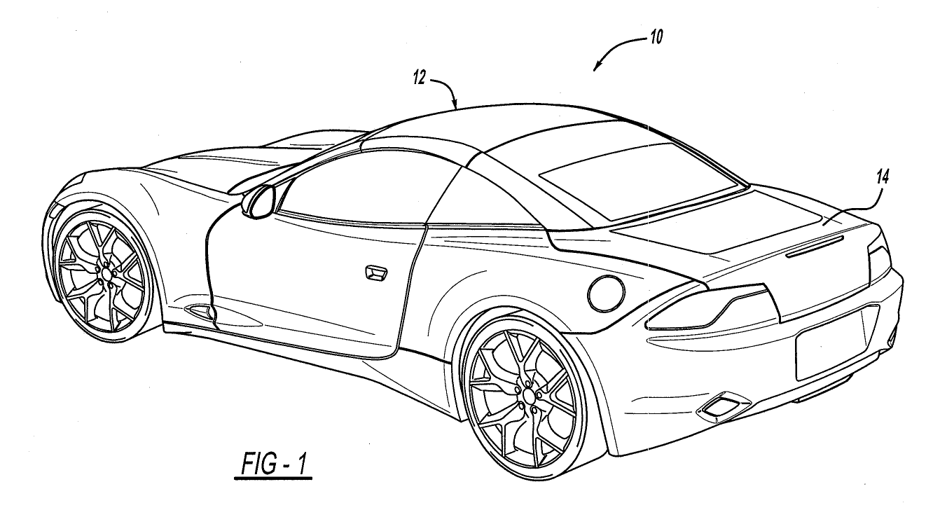

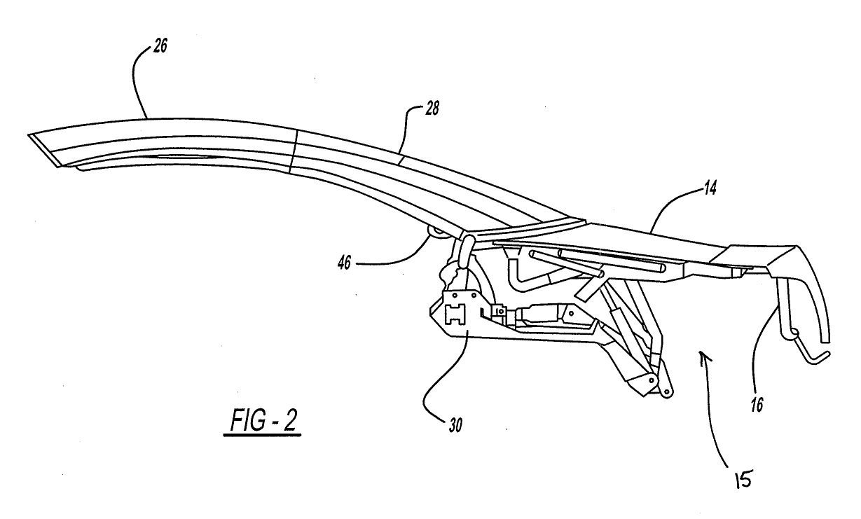

Referring to FIG. 1, a vehicle 10 having a convertible top 12 is illustrated. In this example the vehicle 10 is a motor vehicle having two doors, although in another example the vehicle has more than two doors. The vehicle 10 includes an interior space referred to as a passenger compartment. The passenger compartment is enclosed by a moveable convertible top 12 that covers the passenger compartment in an extended position. The vehicle 10 also includes a storage space referred to as a trunk or luggage compartment. The trunk or luggage compartment is accessible via a deck lid 14.

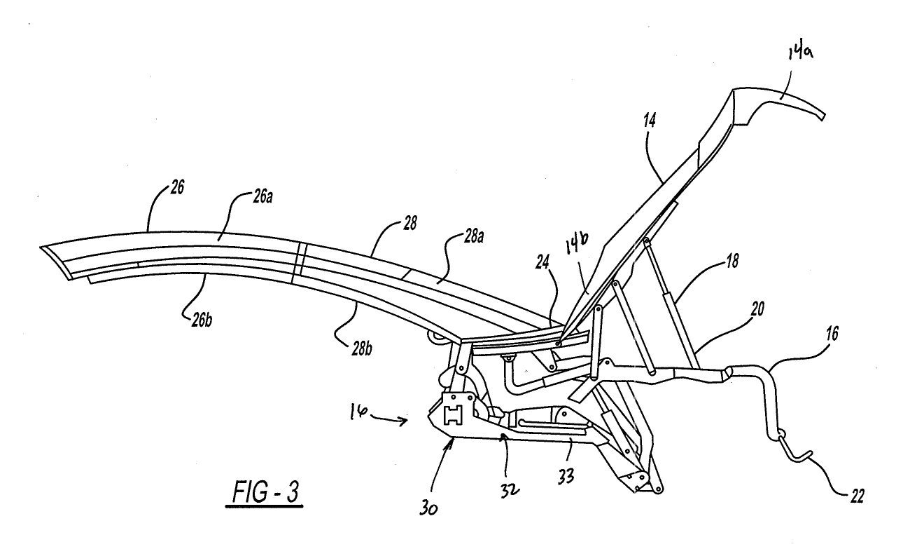

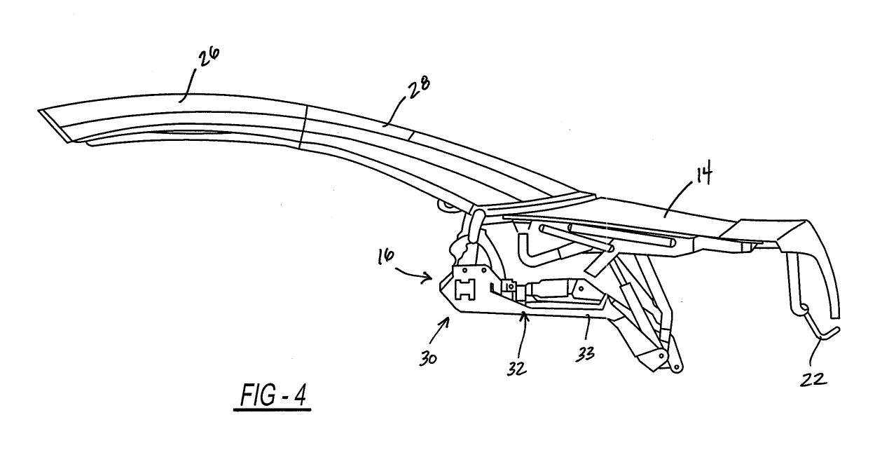

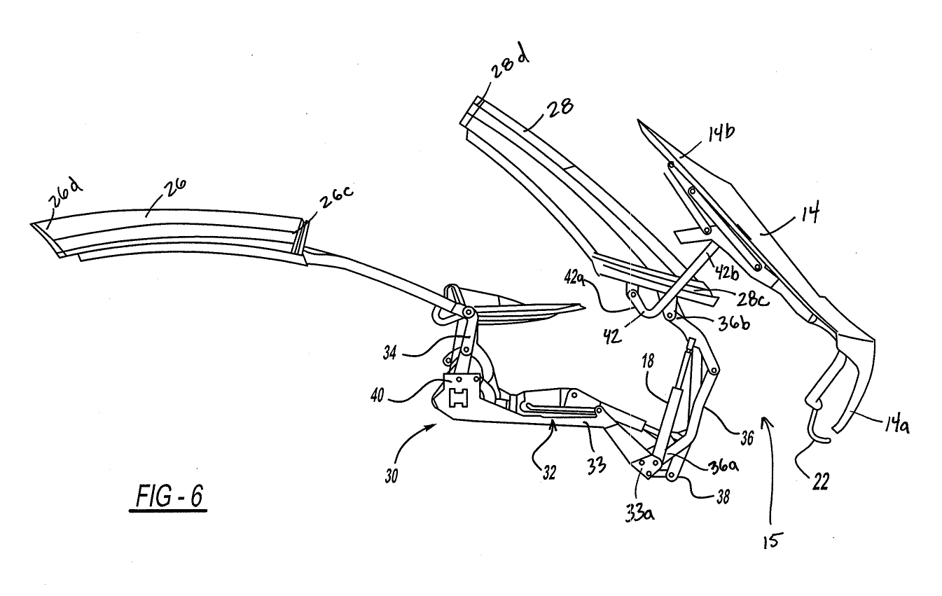

The deck lid 14 is a generally planar panel member pivotally connected to the vehicle body 10 such that the deck lid 14 can articulate in multiple positions. For example, the deck lid 14 may pivot about a forward edge 14b shown in FIG. 3 in order to provide access to the trunk of the vehicle, and the deck lid 14 may pivot about a rearward edge as shown in FIG. 6 in order to stow the folded top within the vehicle trunk. In this example, the deck lid 14 is secured to a deck lid frame 16. The deck lid frame 16 is rigidly supported within the vehicle trunk, and is secured to the vehicle body, such as by a fastener or the like. The deck lid frame 16 may also include a support member 18 for supporting the deck lid 14 in an open position, such as a gas strut or the like. The deck lid frame 16 also includes a deck lid linkage member 20 for controlling articulation of the deck lid 14 about a first pivot point 22 or a second pivot point 24. In this example, the deck lid linkage 20 is a 4-bar linkage, and the pivotal movement of the 4-bar linkage 20 about the first or second pivot points 22, 24 controls the articulating movement of the deck lid 14 either forwardly or rearwardly in a manner to be described.

The convertible top 12 may be fabricated from a hard material or a soft material or a combination thereof. In this example, the convertible top 12 is a hard top. The convertible top 12 includes a front panel 26 and a rear panel 28. Each panel 26, 28 is a rigid, generally planar member. A forwardmost edge 26d of the front panel 26 is connected to the windshield when the convertible top 12 is in an extended position using a latch, such as a header latch (not shown) or the like. Each panel 26, 28 includes an inner surface 26b, 28b and an outer surface 26a, 28a, respectively. The front and rear panel members 26, 28 (rear edge of front panel 26c and front edge of rear panel 28d) may be locked together via panel to panel latches when the convertible top 12 is in an extended position that serve to rigidly interconnect the panels 26, 28. The front panel 26 and rear panel 28 collapse or fold when the convertible top 12 is retracted in a manner to be described. With the convertible top 12 extended, the forward edge of the rear section 28 is adjacent the rearward edge of the front section 26, and the rearward edge of the rear section 28 is adjacent the vehicle body.

The convertible top 12 is connected to the vehicle body via a main pivot bracket 30. The main pivot bracket 30 is fixedly attached to the vehicle body using a connector, such as a bolt or the like. The main pivot bracket 30 includes a plurality of interconnected, symmetrical, pivotal links 31. Movement of the main pivot bracket 30 causes the front panel 26 and rear panel 28 to articulate in a. manner to be described, so that the outer surface of the front panel 26a and inner surface of the rear panel 28b are adjacent one another when the top 12 is retracted and stowed within the storage area 15 (e.g., vehicle trunk, etc.). Movement of the main pivot bracket 30 is controlled by an actuator between the extended and stowed positions.

The main pivot bracket 30 includes a base member 32 that is secured to the vehicle 12. The base member 32 may be a frame having symmetrical side members 33. A lower end of a front link 34 is pivotally secured to a forward end of the side member so that the front panel 26 pivots about a fourth pivot axis 40. The front link 34 is an elongated member. A rear edge of the front panel 26 is pivotally attached to an upper end of the front link 34. The main pivot bracket 30 also includes a rear link 36 having a lower end 36a pivotally secured to a rearward end 33a of the side member 33 and an upper end 36b pivotally secured to a rear edge 28c of the rear panel 28. The rear panel pivots about a third pivot axis 38.

The convertible top assembly 12 may include a downstack receiver that is conventional in the art (not shown and latch assembly bat is conventional in the art (not shown) for supporting and/or retaining the retracted hardtop components in the storage area when the top is retracted. The downstack receiver receives and supports the panels 26, 28 in the stowed position. In an example, the downstack receivers are provided in the front portion of the trunk storage area 15.

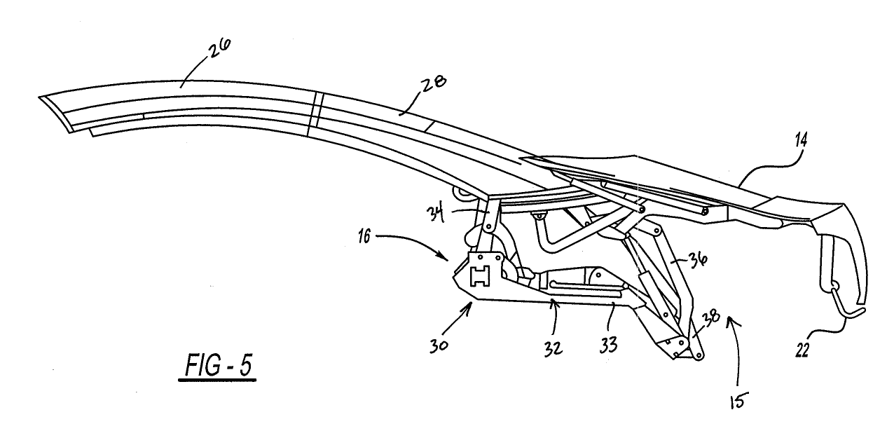

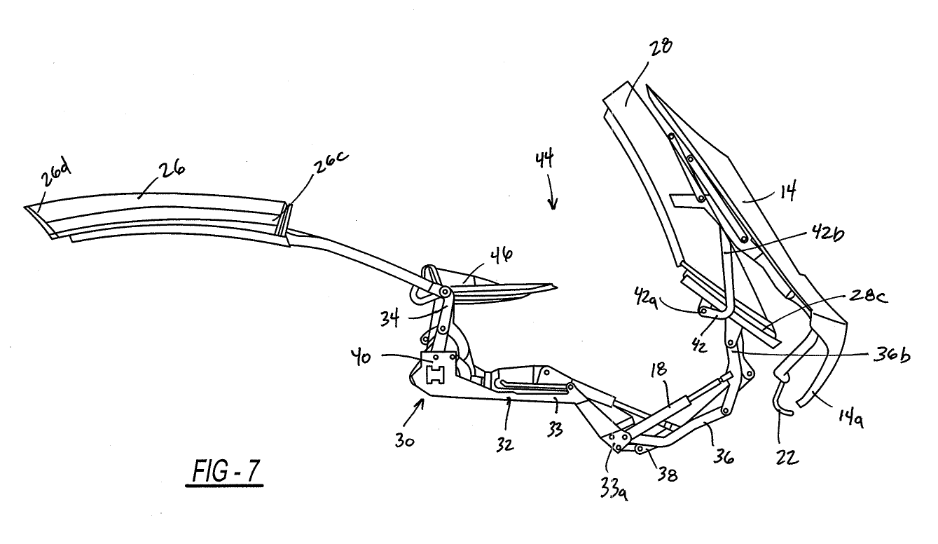

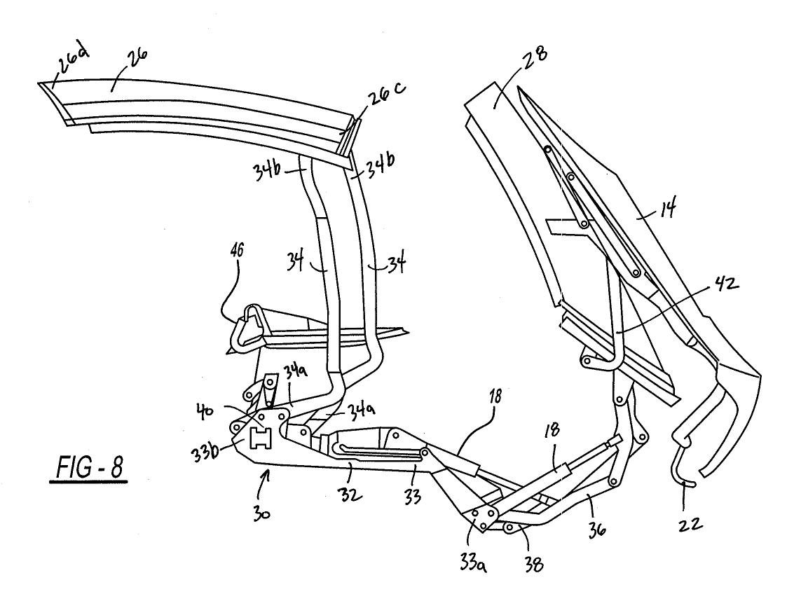

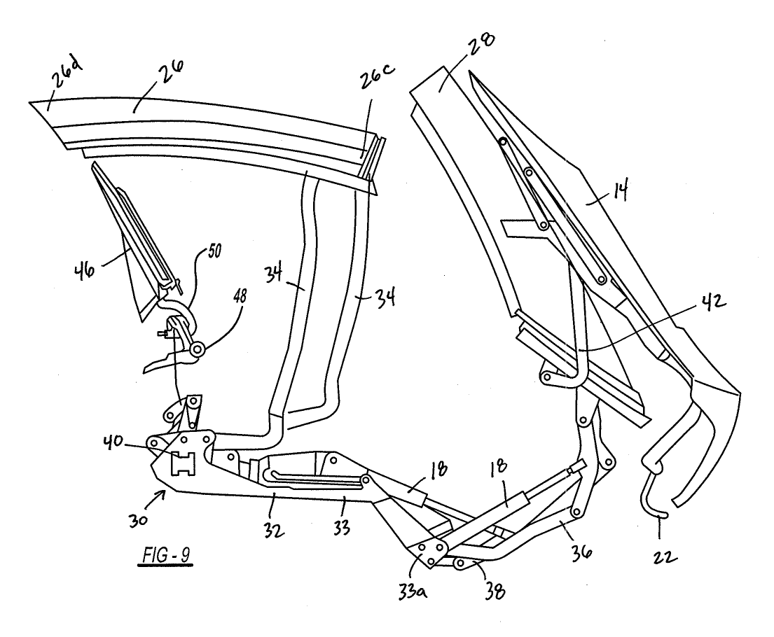

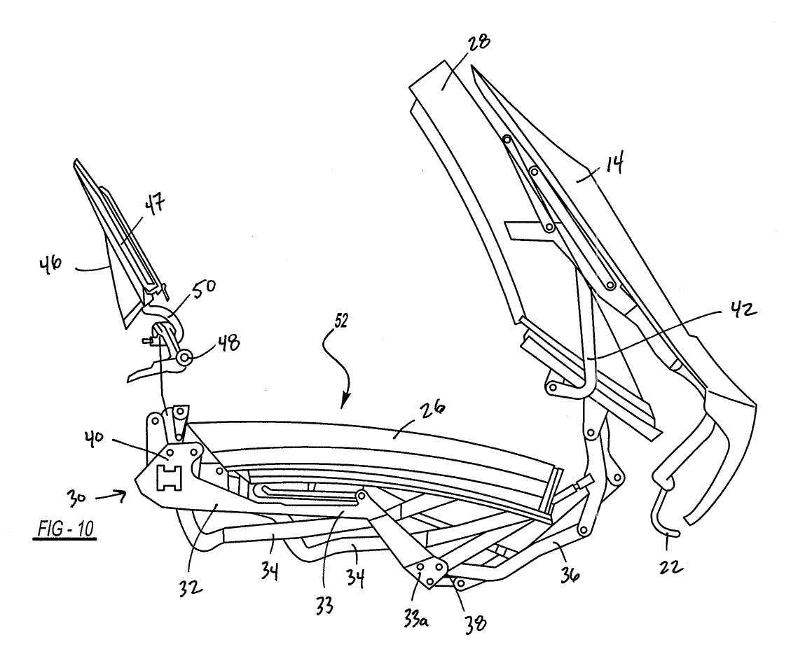

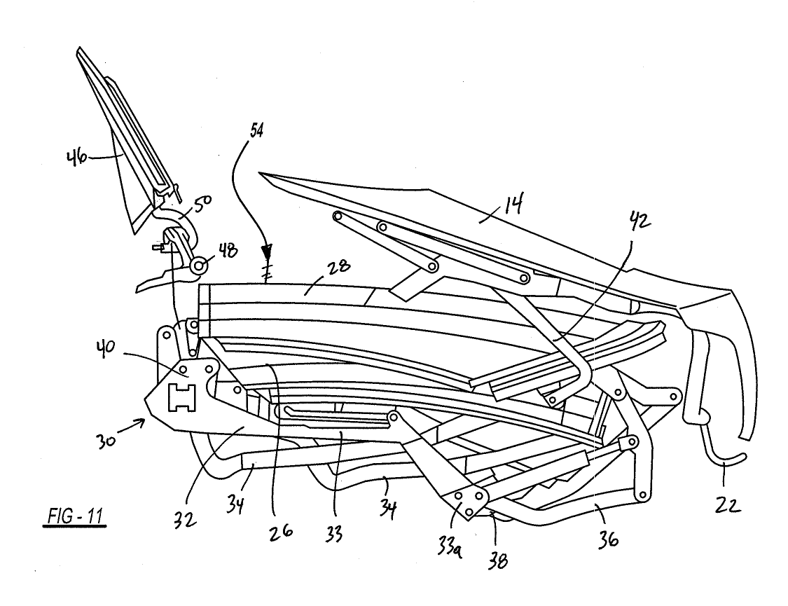

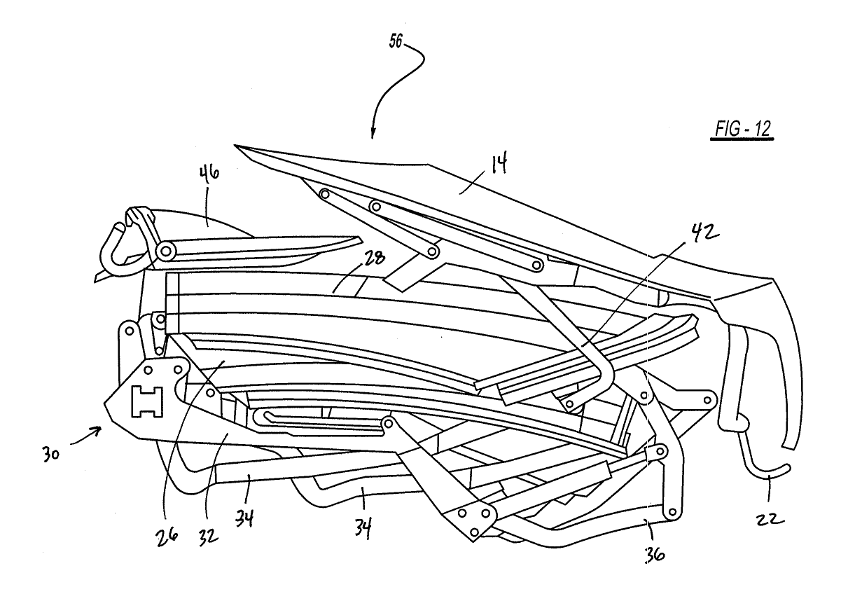

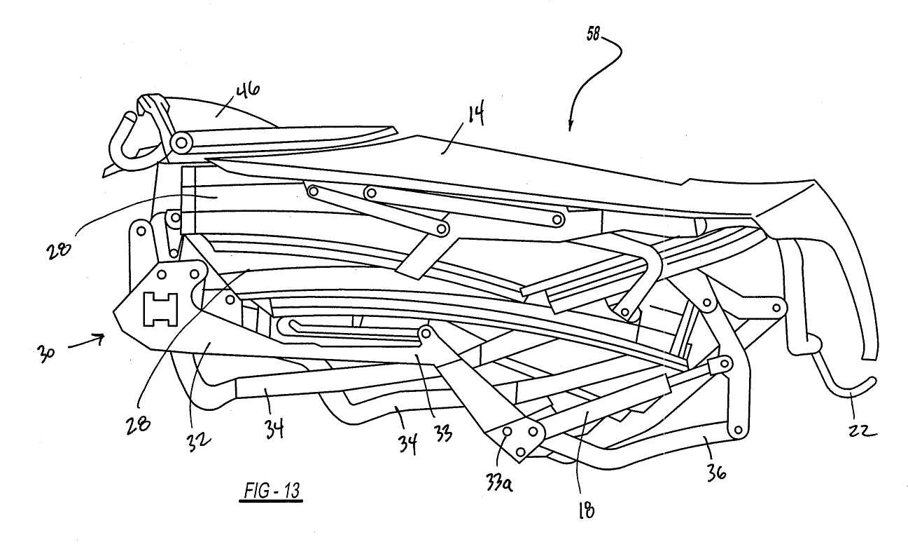

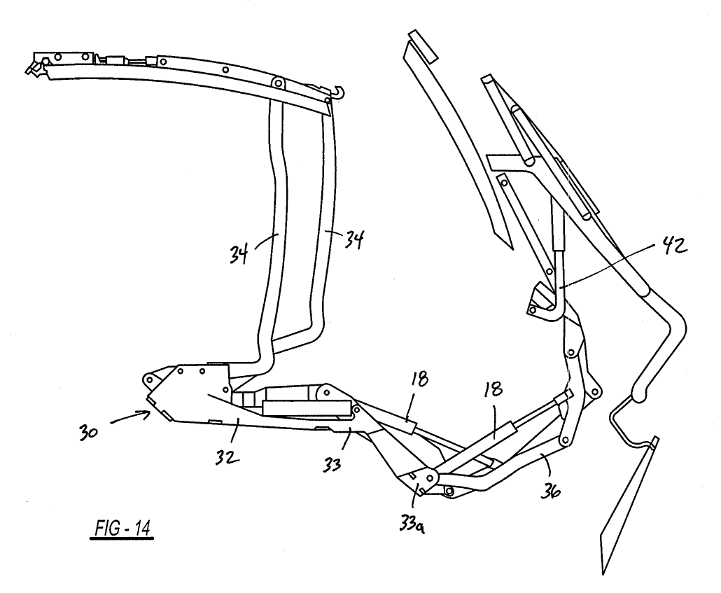

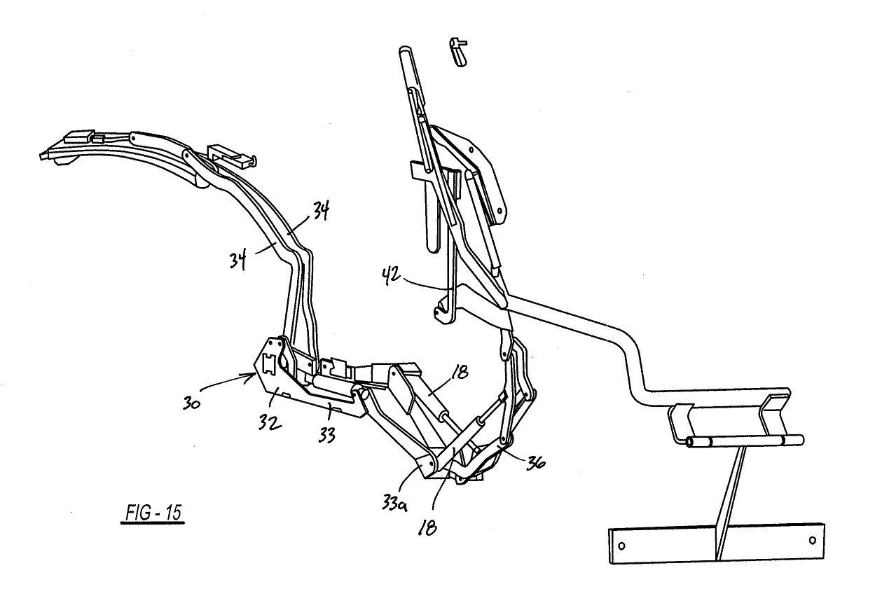

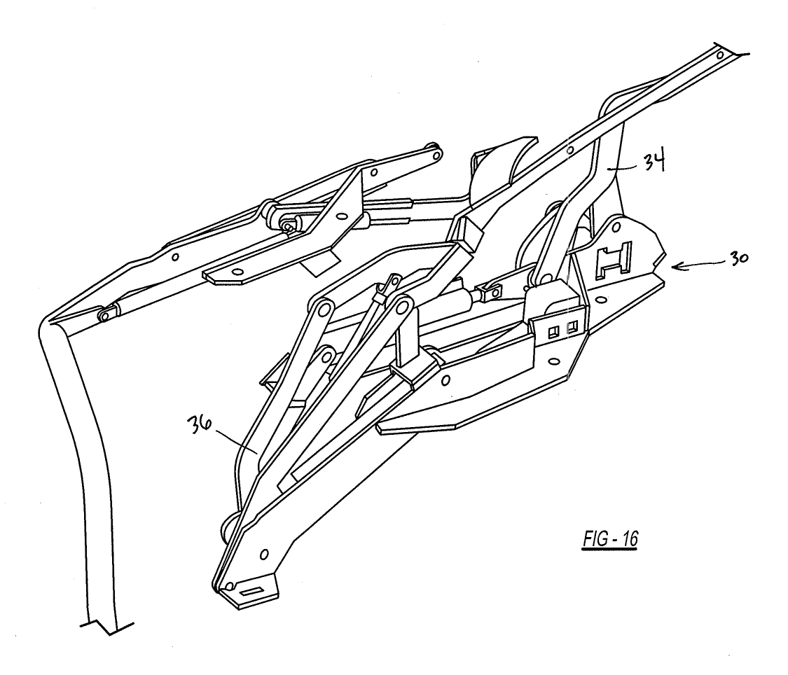

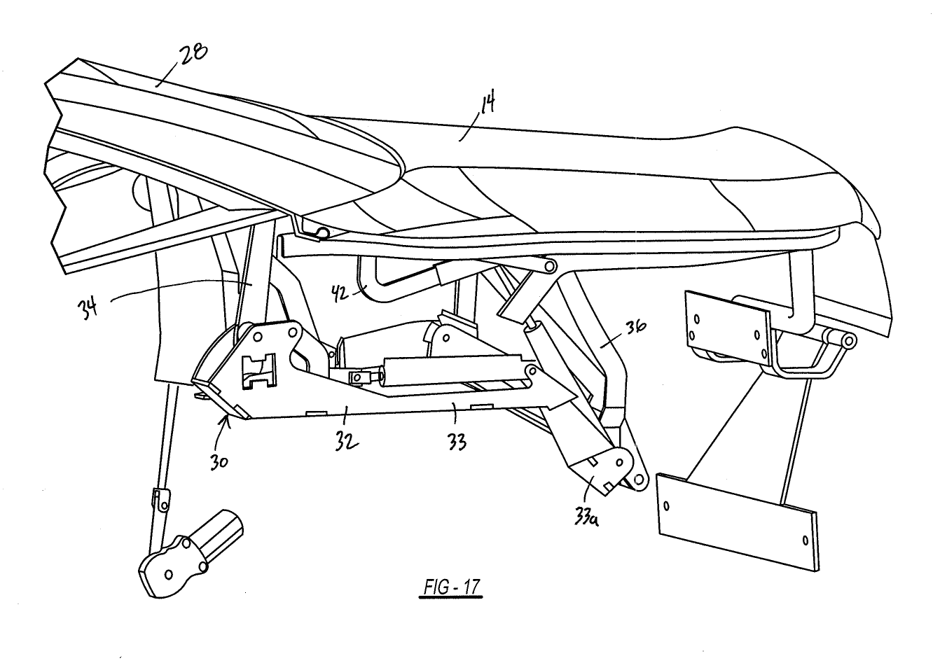

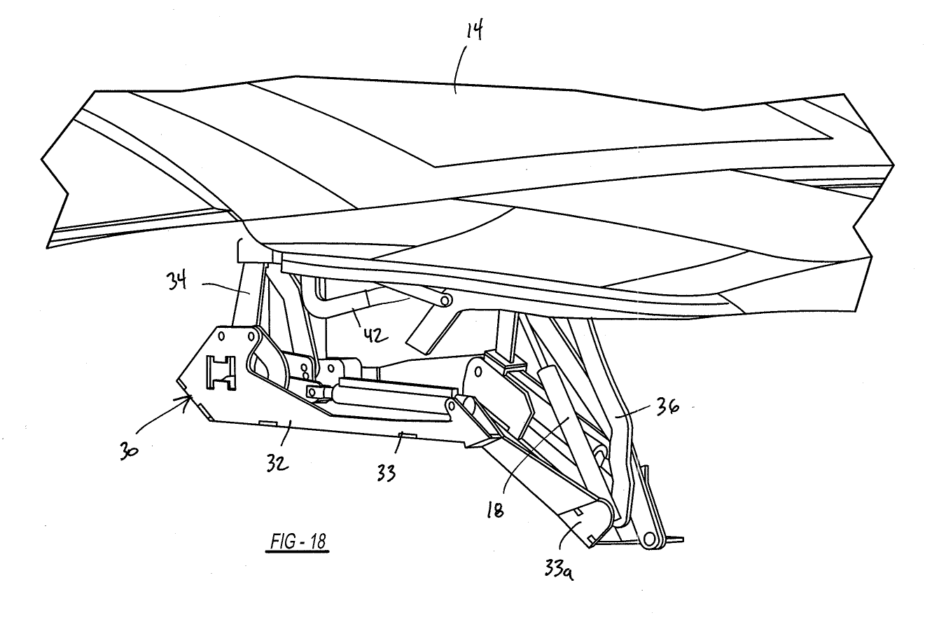

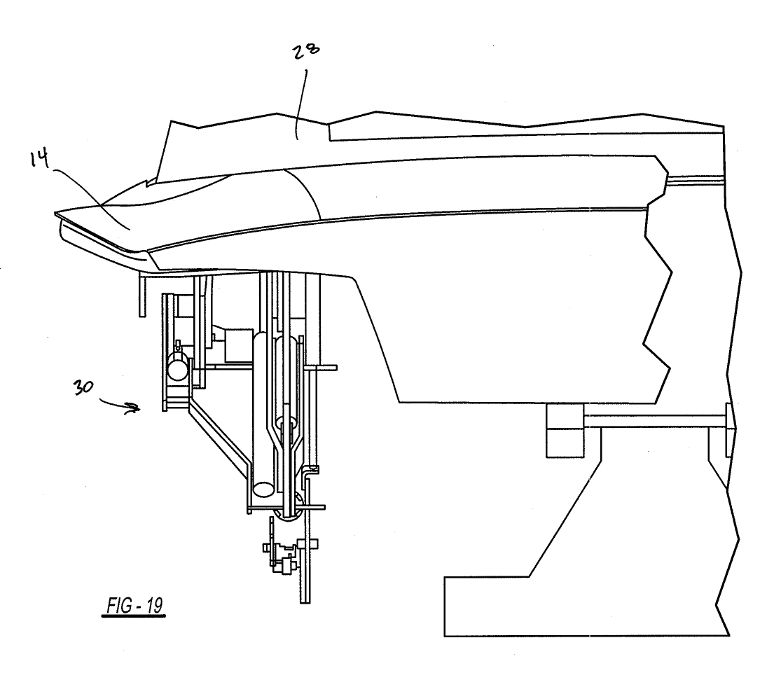

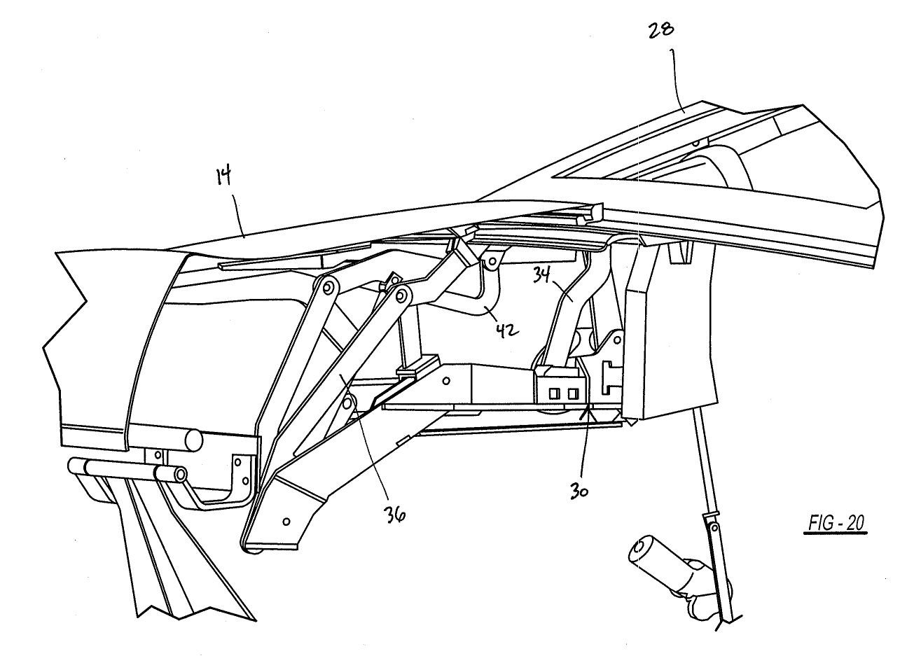

The convertible top assembly 12 is controlled by a control system e.g., electronic, manual, etc.) that is conventional in the art (not shown) that operatively controls a specific sequence of operations for opening or stowing the convertible top 12 and for closing or extending the convertible top 12. Various steps in the sequence may occur simultaneously. The opening sequence is as follows. The user operates a switch (not shown) that is conventional in the art which opens a latch at a predetermined time, such as the header latches, panel latches and deck lid latches. The switch can be located at any appropriate location that is convenient such as the front console, dash, or the like. The deck lid 14 and deck lid frame 16 pivot upwardly about a rearmost edge of the deck lid 14a along the first pivot axis 22 via a connection link, to uncover the trunk compartment 15 as shown in FIGS. 5 and 6. At the same time, the rearmost edge of the rear panel 28c pivots about a third pivot axis 38 due to pivotal movement of the rear link 36. An assist or support device 18 such as a hydraulic cylinder may be utilized to pivotally move the rear panel 28. A connecting link 42 has one end 42a connected to the rear panel 28 and another end 42b connected to the deck lid 14 for coordinated movement. When the deck lid 12, deck lid frame 16 and rear panel 28 attain a predetermined opening position, as shown in FIG. 7 at 44, articulation of the front panel 26 is initiated about the fourth pivot axis 40. The rearmost edge 26c of the front panel 26 is pivotally secured to the front link 34 having a lower end 34a pivotally secured to a forward end 33b of the side member 33 and an upper end 34b pivotally secured to a rear edge 26c of the front panel 26. An assist or support device 18, such as a hydraulic cylinder may interconnect the main pivot bracket 30 and the main front link 34, to assist in movement of the front panel 26, as shown in FIG. 8. As the front panel 26 is pivoting, a tonneau cover 46 may also be actuated, as shown in FIG. 9. The tonneau cover 46 rotates about a fifth pivot axis shown at 48. A hinge, such as the goose neck hinge shown at 50, enables the front panel 26 to pass over the tonneau cover 46 and under the rear panel 28 to stow in the storage compartment or trunk, as shown in FIG. 10 at 52. Once the front panel 26 reaches the end of its cycle, the cover flaps 47 on the tonneau cover 46 are rotated in an outwardly direction. For example, an actuator (not shown) such as a motor (i.e. electric) and a cable (i.e. pull cable) control the operation of the tonneau cover 46. The free end of the rear panel 28 then pivots downwardly about the third pivot axis 38 to complete the closing cycle as shown in FIG. 11 at 54. The assist or support mechanism or hydraulic cylinder may effectuate this movement. The rear or front panel 28, 26 is held in place such as using a pull down link downstack receiver bracket (not shown). The tonneau cover 46 is lowered back to its nominal position as shown in FIG. 12 at 56. The deck lid 14 closes and is latched as shown in FIG. 13 at 58 using a latch (not shown). The described procedure is reversed in order to raise the top.

The convertible top assembly 12 may include other features, such as a switch (not shown) for operating the top 12. The switch may be in a remotely located, such as on a key fob, or integrally located on the vehicle 10. The control may send a command to a window controller to lower a side window prior to cycling the top. A warning chime may be provided which indicates movement of the top 12. Similarly, raising or lowering of the top 12 may only be allowed under a predetermined vehicle condition, such as when the vehicle 10 is parked. The system may include a number of sensors, such as limit switches that sense the various conditions, such as latch engagement, panel position or the like. The system may include a sensor which determines if the luggage occupies the trunk, and determines if the top 12 can cycle. The system may include an overload sensor for determining if the actuators exceed a given load. In addition, the system may cease operation if an expected condition is not sensed within a predetermined timeout period.

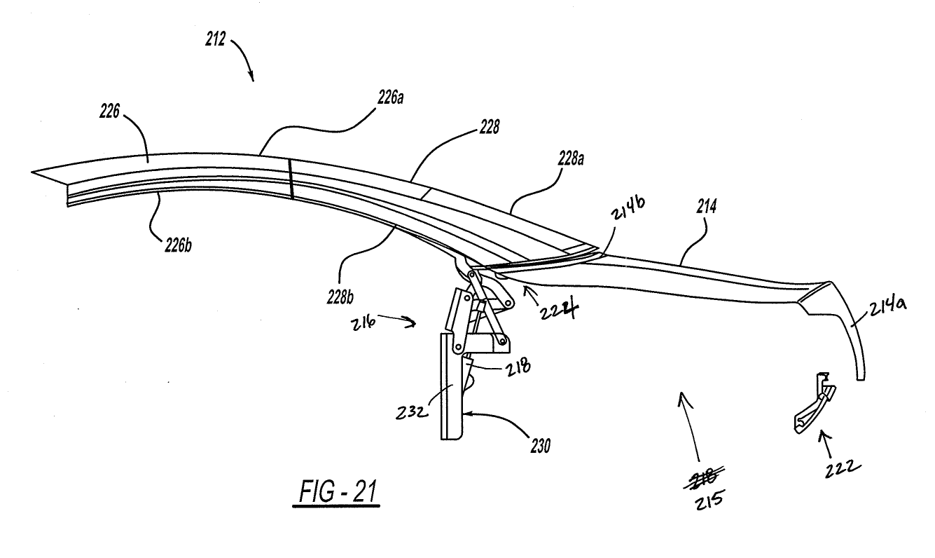

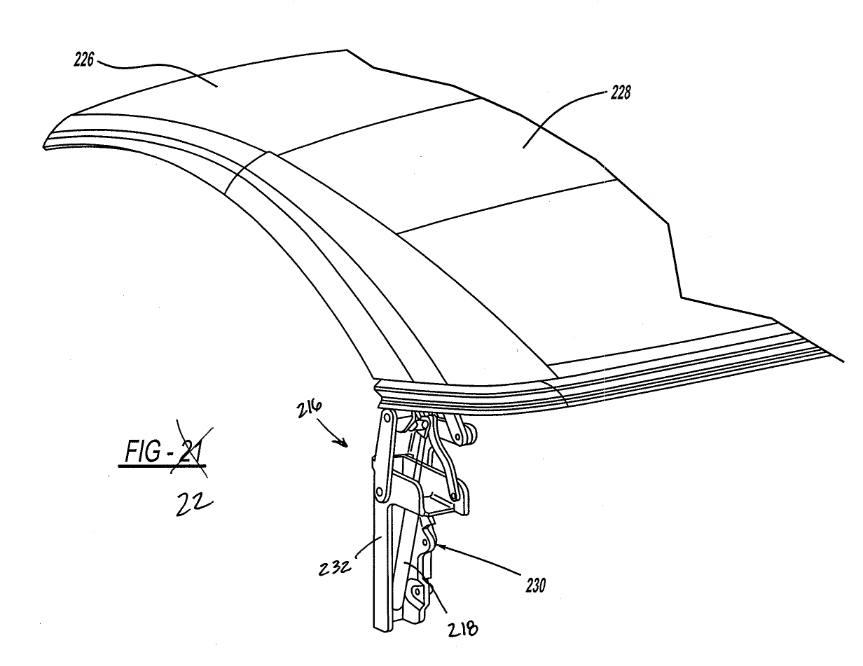

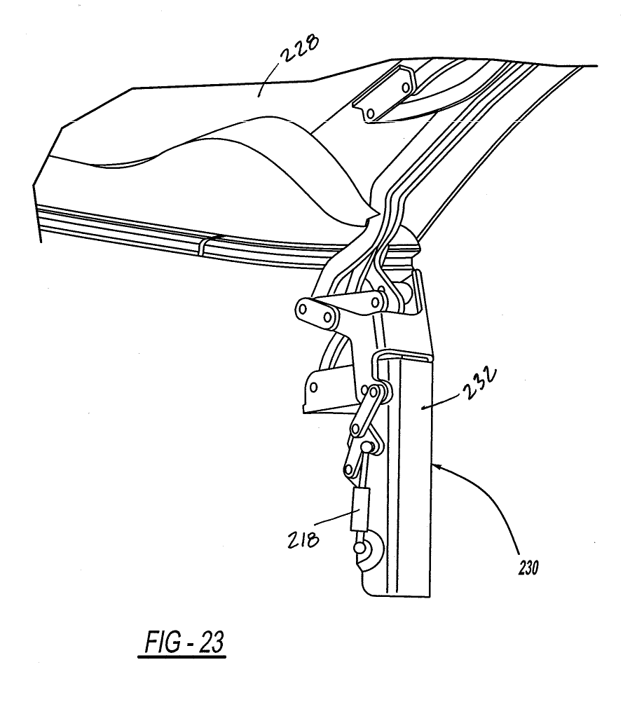

Referring now generally to FIGS. 21-23, a convertible top assembly 212 according to an alternate embodiment is shown where like features have reference numbers increased by two hundred. The deck lid 214 is a generally planar panel member pivotally connected to the vehicle body 10 such that the deck lid 214 can articulate in multiple positions. For example, the deck lid 214 may pivot about a forward edge 214b in order to provide access to the trunk of the vehicle 215, and the deck lid 214 may pivot about a rearward edge 214a in order to stow the folded top within the vehicle trunk 215. The deck lid 214 can be secured to a deck lid frame (not shown). The deck lid frame can be rigidly supported within the vehicle trunk 215, and secured to the vehicle 210 body, such as by a fastener or the like. The deck lid frame may also include a support member for supporting the deck lid 214 in an open position, such as a gas strut or the like. The deck lid frame may also include deck lid linkage members for controlling articulation of the deck lid 214 about a first pivot point 222 or a second pivot point 224.

The convertible top 212 may be fabricated from a hard material or a soft material or a combination thereof. In this example, the convertible top 212 is a hard top. The convertible top 212 includes a front panel 226 and a rear panel 228. Each panel 226, 228 is a rigid, generally planar member. A forwardmost edge 226d of the front panel 226 is connected to the windshield when the convertible top 212 is in an extended position using a latch that is conventional in the art (not shown), such as a header latch or the like. Each panel 226, 228 includes an inner surface 276b, 228b and an outer surface 226a, 228a, respectively. The front and rear panel members 226, 228 (rear edge of front panel 226c and front edge of rear panel 228d) may be locked together via panel to panel latches when the convertible top 212 is in an extended position that serve to rigidly interconnect the panels 226, 228. The front panel 226 and rear panel 228 collapse or fold when the convertible top 212 is retracted in a manner to be described. With the convertible top 212 extended, the forward edge of the rear section 228 is adjacent the rearward edge 226c of the front section 226, and the rearward edge 228c of the rear section 228 is adjacent the vehicle body.

The convertible top 212 is connected to the vehicle body via a main pivot bracket 230. The main pivot bracket 230 is fixedly attached to the vehicle body using a connector, such as a bolt or the like. The main pivot bracket 230 includes a plurality of interconnected, symmetrical, pivotal links 231. Movement of the main pivot bracket 230 causes the front panel 226 and rear panel 228 to articulate in a manner to be described, so that the outer surface of the front panel 226a and inner surface of the rear panel 228b are adjacent one another when the top 212 is retracted and stowed within the storage area 215. Movement of the main pivot bracket 230 is controlled by an actuator that is conventional in the art (not shown)between the extended and stowed positions.

The main pivot bracket 230 includes a base member 232 that is secured to the vehicle 212. The base member 232 may be a frame having symmetrical side members 233. A lower end 234a of a front link 234 is pivotally secured to a forward end 233a of the side member 233 so that the front panel 226 pivots about a fourth pivot axis 240. The front link 234 is an elongated member. A rear edge 226c of the front panel 226 is pivotally attached to an upper end 234b of the front link 234. The main pivot bracket 230 also includes a rear link 236 having a lower end 236a pivotally secured to the upper end 234b of the front link 234 and an upper end 236b pivotally secured to a rear edge 228c (or front edge 228d, or middle section 228e, or another portion of the rear panel) of the rear panel 228. The rear panel 228 pivots about a third pivot axis 238.

The convertible top assembly 212 may include a downstack receiver that is conventional in the art (not shown and latch assembly that is conventional in the art (not shown) for supporting and/or retaining the retracted hardtop components in the storage area 215 when the top 212 is retracted. The downstack receiver receives and supports the panels 226, 228 in the stowed position. In an example, the downstack receivers are provided in the front portion of the trunk storage area 215.

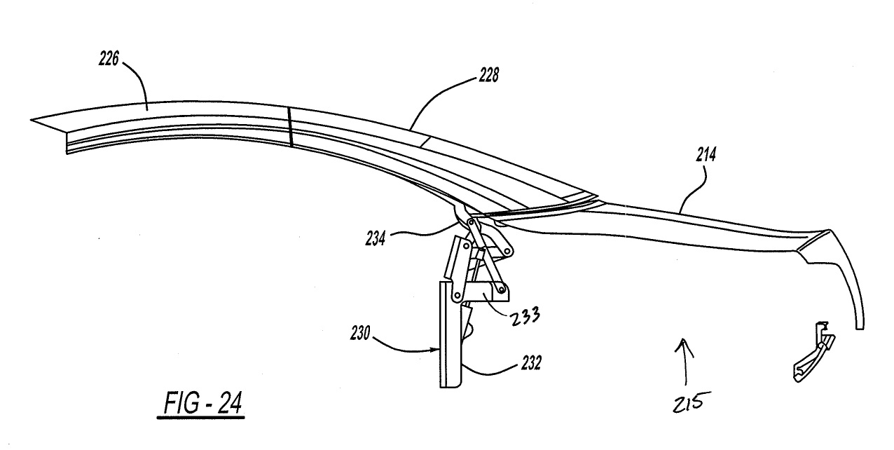

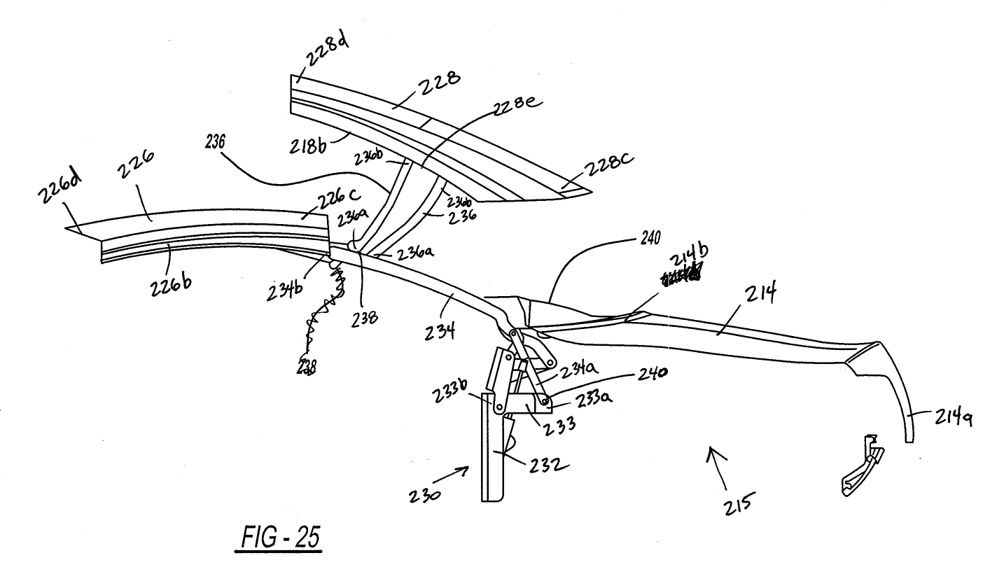

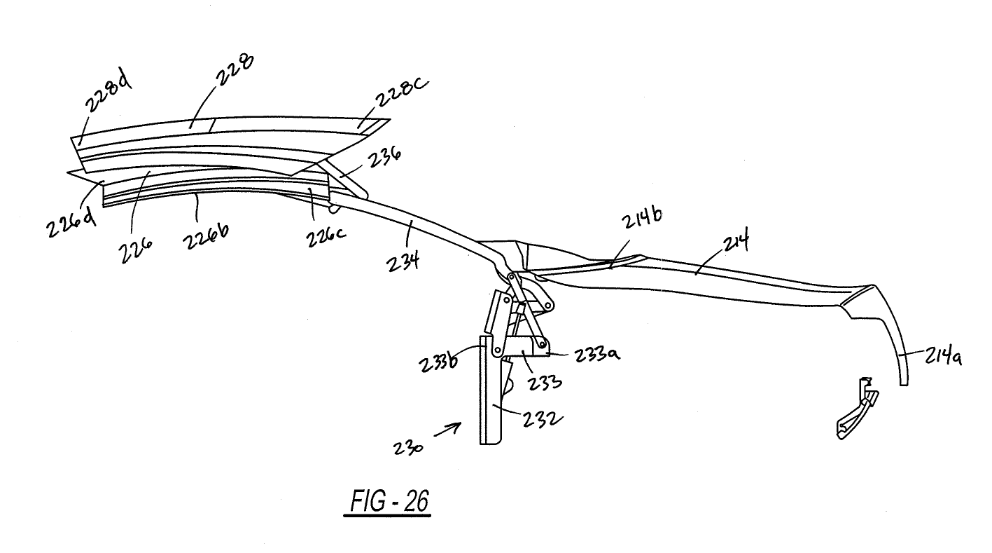

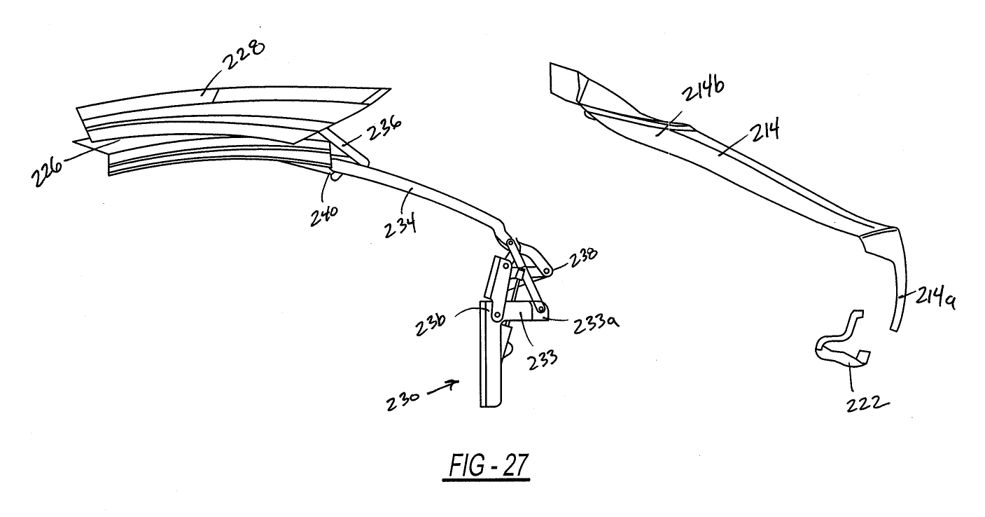

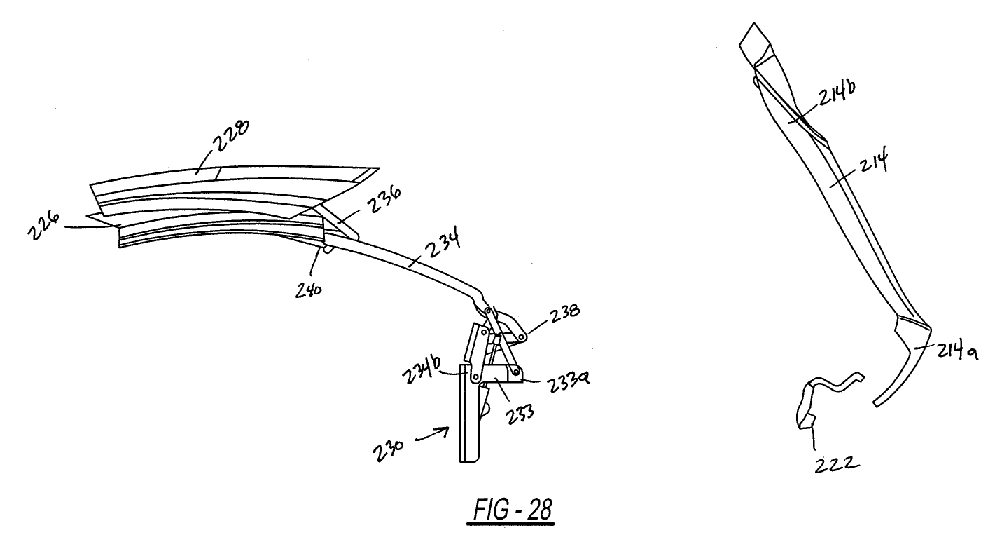

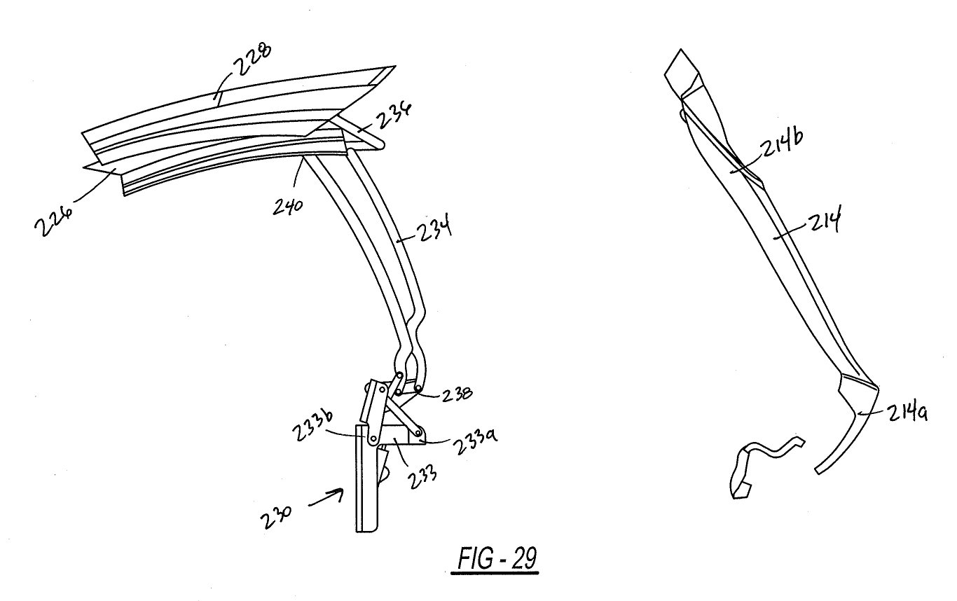

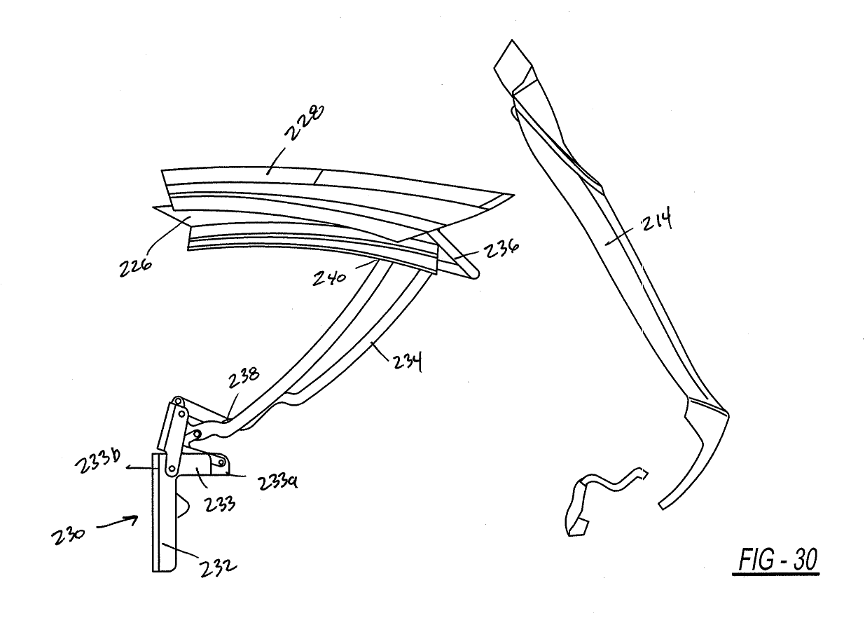

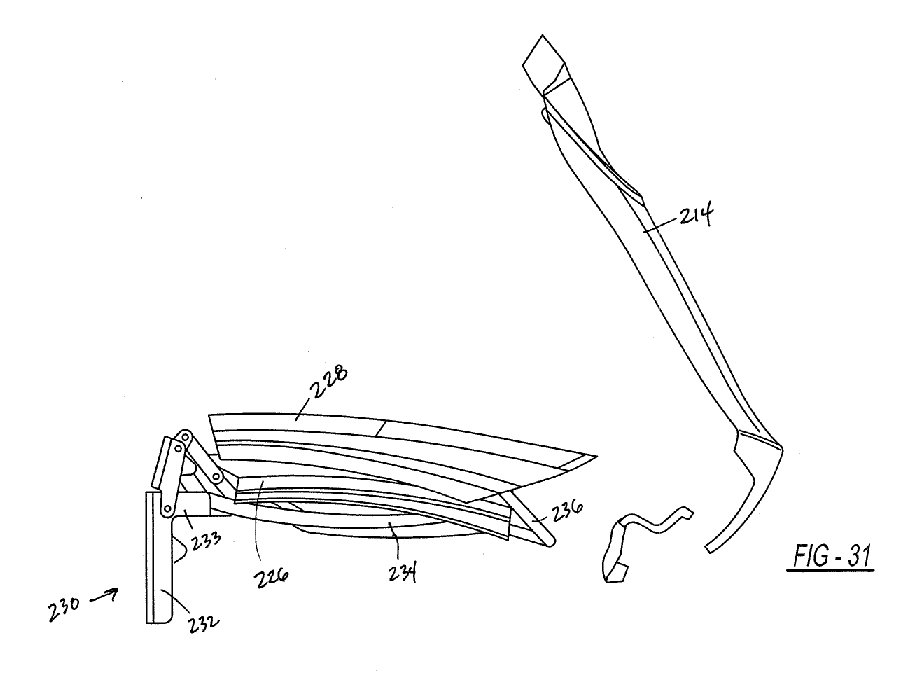

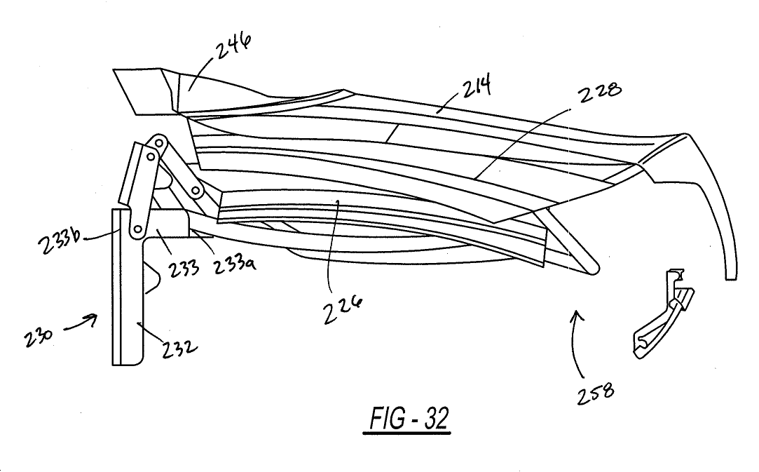

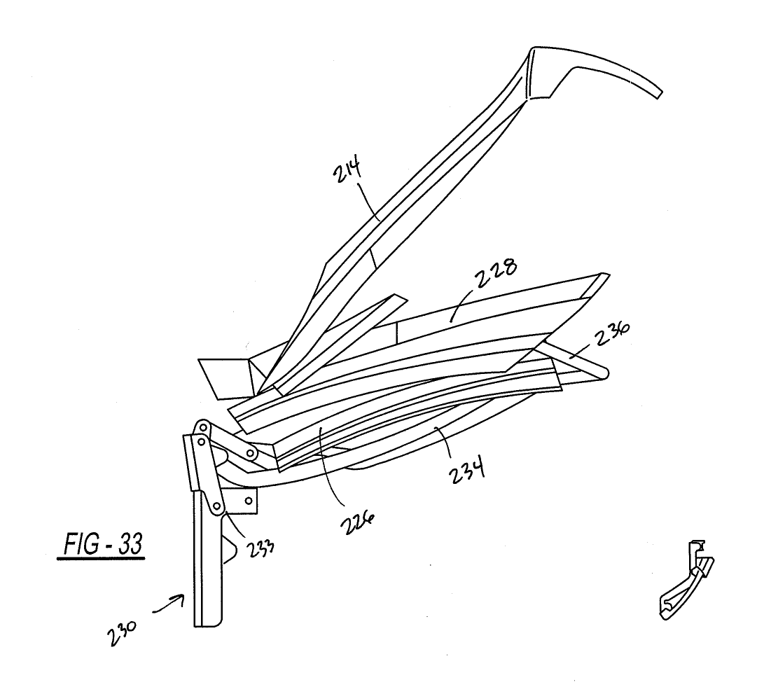

Referring now to FIGS. 24-33, the steps for opening the convertible top assembly 212 is shown. The convertible top assembly 212 is controlled by a control system (not shown) that operatively controls a specific sequence of operations for opening or stowing the convertible top 212 and for closing or extending the convertible top 212. Various steps in the sequence may occur simultaneously. The opening sequence is as follows. The user operates a switch (not shown) which opens a latch at a predetermined time, such as the header latches, panel latches and deck lid latches. The rear panel 228 pivots upwardly about the third pivot axis 238 via the rear link 236 until the inner surface 228b of the rear panel 228 is adjacent to the outer surface 226a of the front panel 226, as shown in FIGS. 25 and 26. The deck lid 214 pivots upwardly about a rearmost edge along the first pivot axis 222, as shown in FIGS. 27 and 28. At the same time, the front panel 226 pivots simultaneously about a third pivot axis (floating pivot point) 238 and a fourth pivot axis 240 due to pivotal movement of the front link 234, as shown in FIGS. 29 and 30. An assist or support device 218 such as a hydraulic cylinder may be utilized to pivotally move the front panel 226. The rearmost edge of the front panel 226 is pivotally secured to the front link 234. An assist or support device 218, such as a hydraulic cylinder may interconnect the main pivot bracket 230 and the main front link 234, to assist in movement of the front panel 226, as shown in FIGS. 29-30. The front panel 226 (and rear panel 228) continues to pivot downwardly until it is stowed in the storage compartment or trunk 215, as shown in FIG. 31 at 252. The assist or support mechanism or hydraulic cylinder may effectuate this movement. The rear or front panel 228, 226 is held in place such as using a pull down link downstack receiver bracket (not shown). Once the front panel 226 (and rear panel 228) reaches the end of its cycle, the deck lid 214 closes and is latched as shown in FIG. 32 at 258. The deck lid may also include a tonneau cover 246. The described procedure is reversed in order to raise the top 212.

The convertible top assembly 212 may include other features, such as a switch (not shown) for operating the top 212. The switch may be in a remotely located, such as on a key fob, or integrally located on the vehicle 210. The control may send a command to a window controller to lower a side window prior to cycling the tope. A warning chime may be provided which indicates movement of the top 212. Similarly, raising or lowering of the top 212 may only be allowed under a predetermined vehicle condition, such as when the vehicle 210 is parked. The system may include a number of sensors, such as limit switches that sense the various conditions, such as latch engagement, panel position or the like. The system may include a sensor which determines if the luggage occupies the trunk, and determines if the top 212 can cycle. The system may include an overload sensor for determining if the actuators exceed a given load. In addition, the system may cease operation if an expected condition is not sensed within a predetermined timeout period.

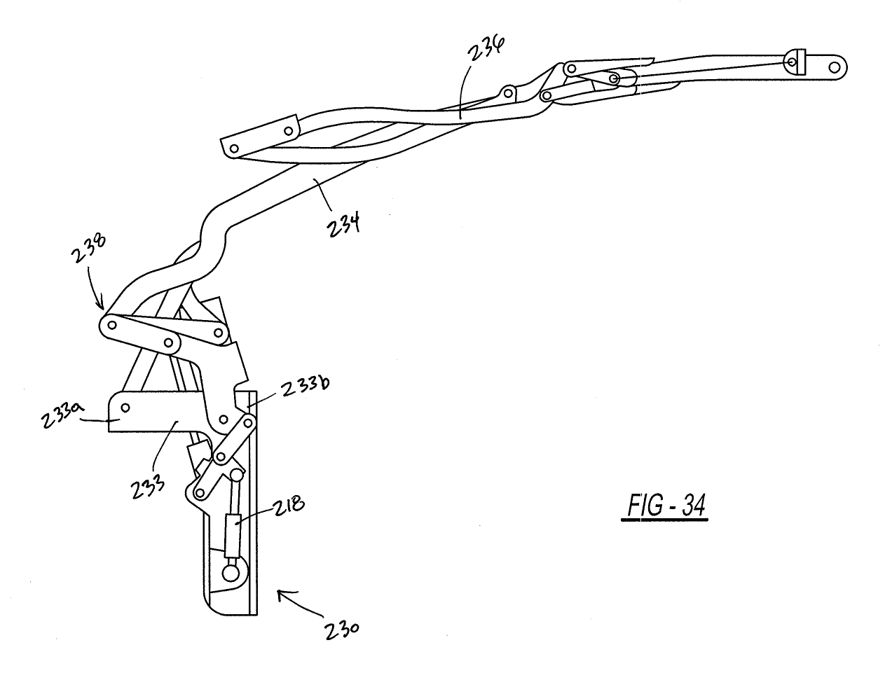

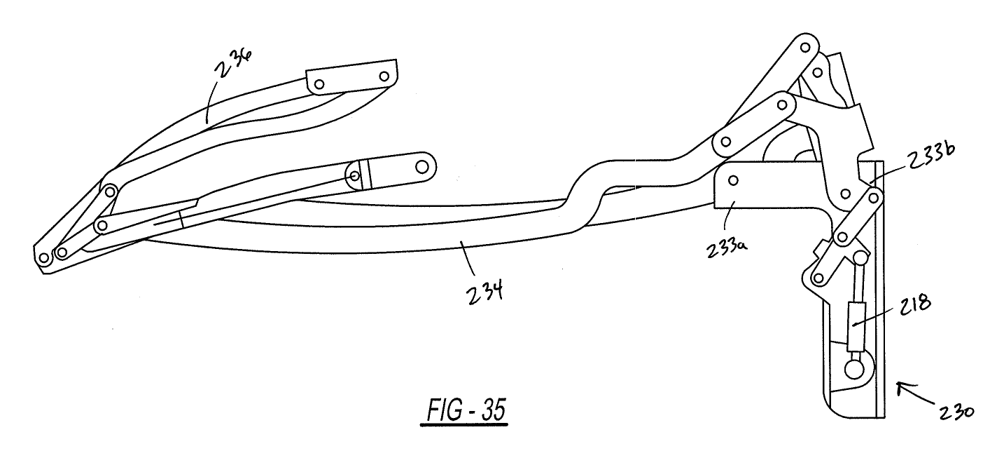

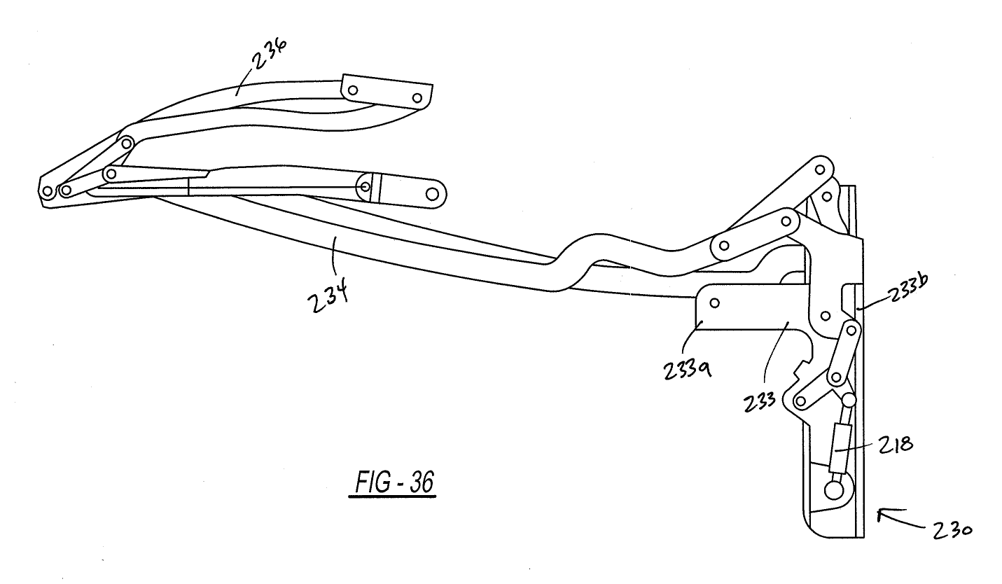

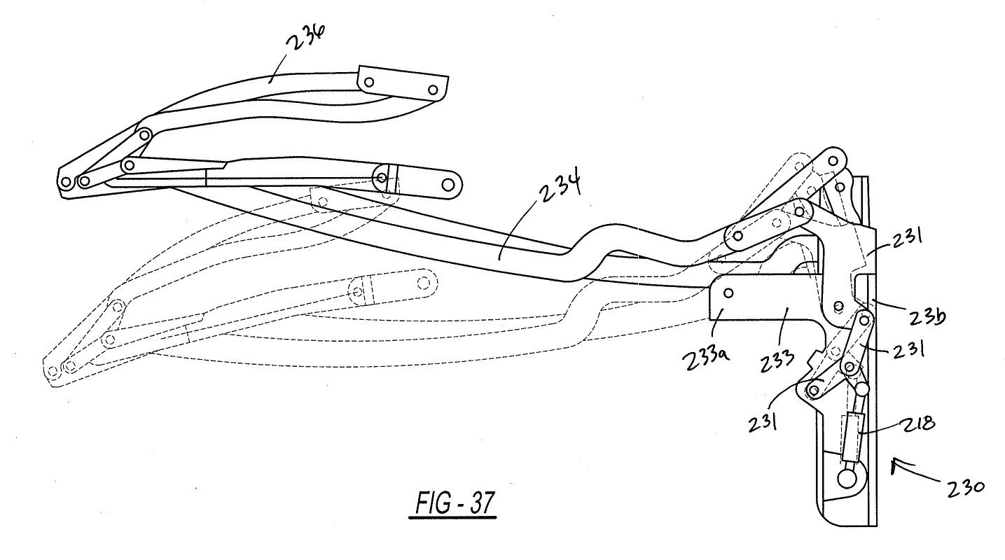

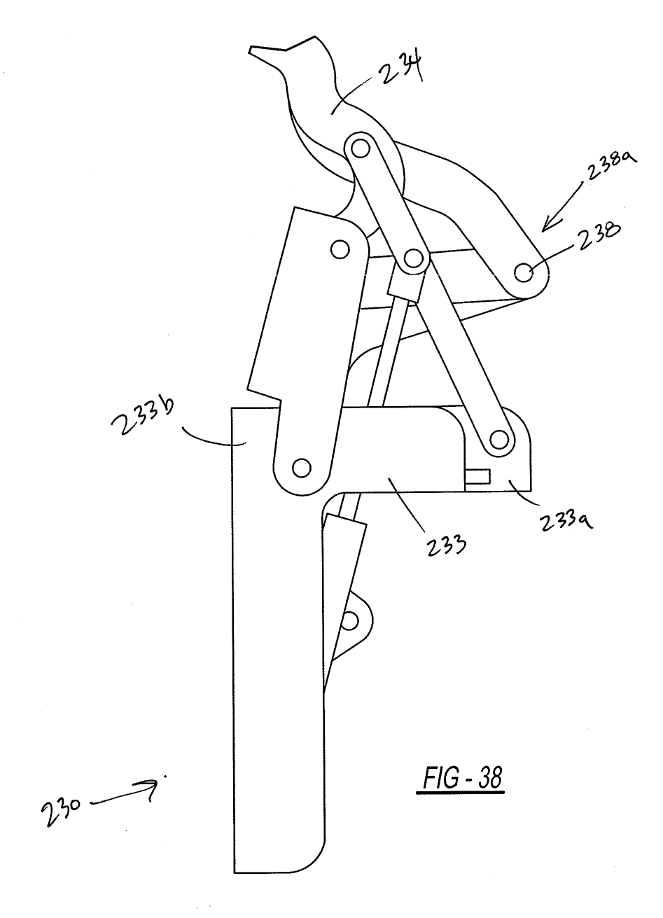

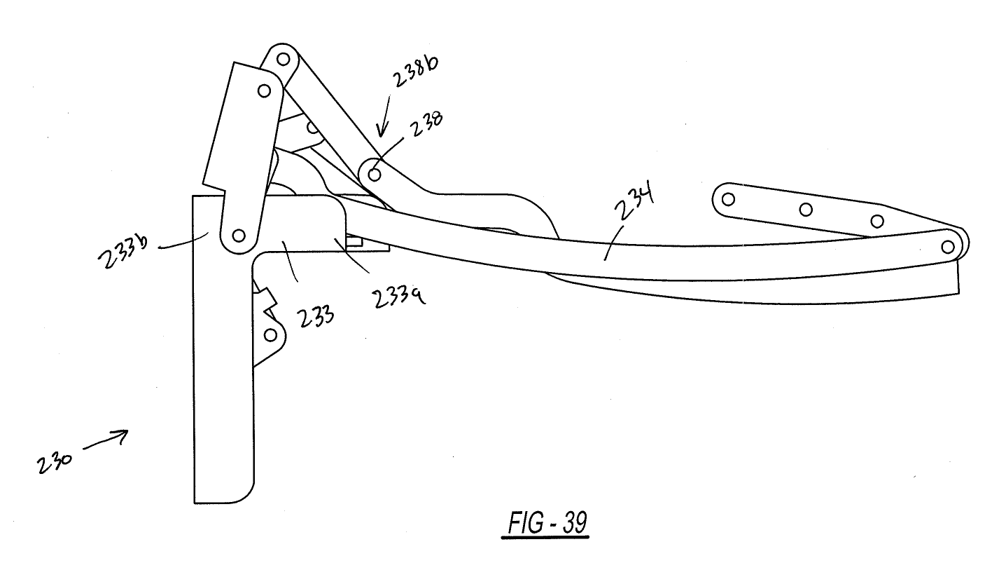

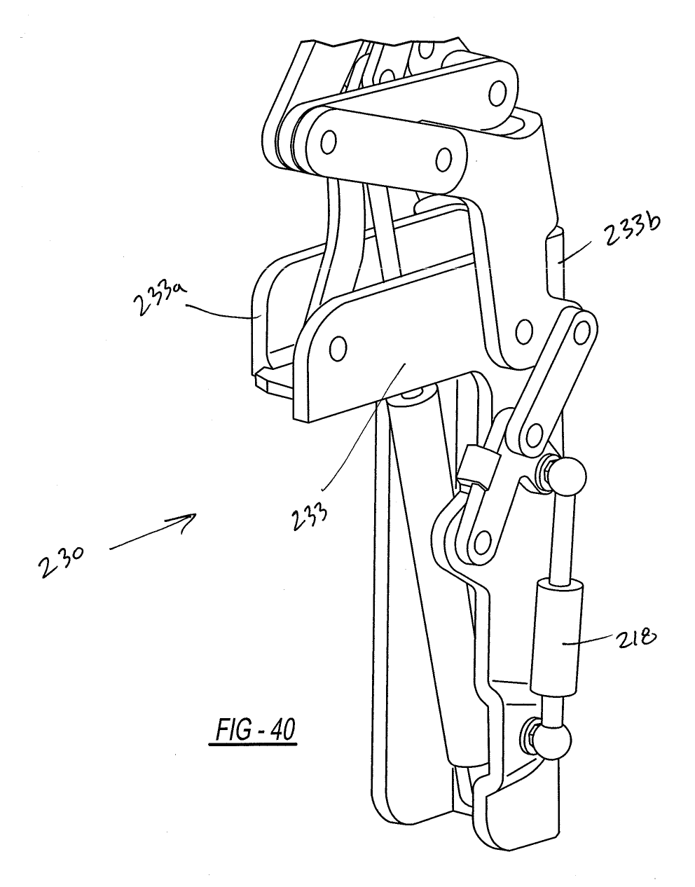

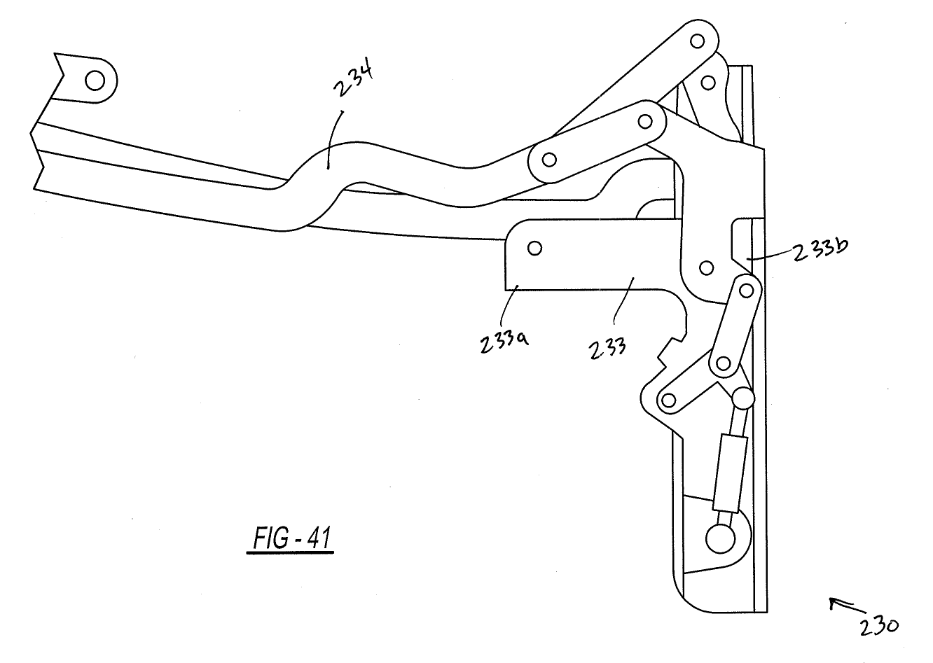

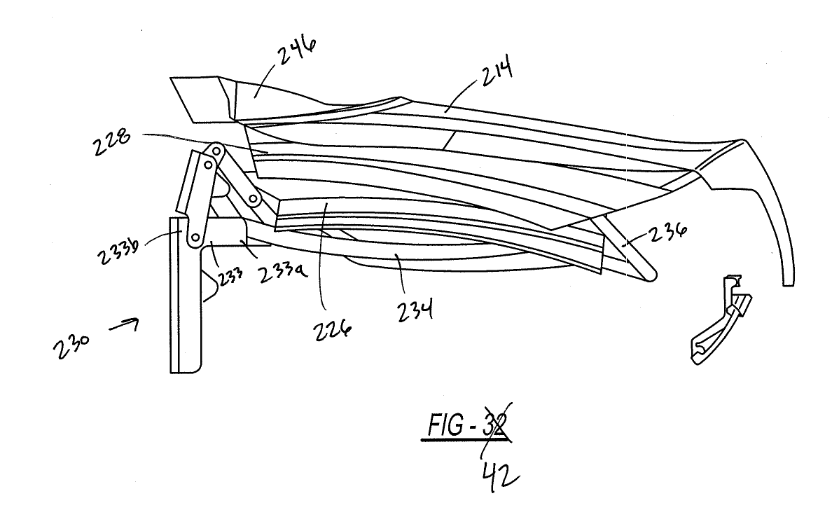

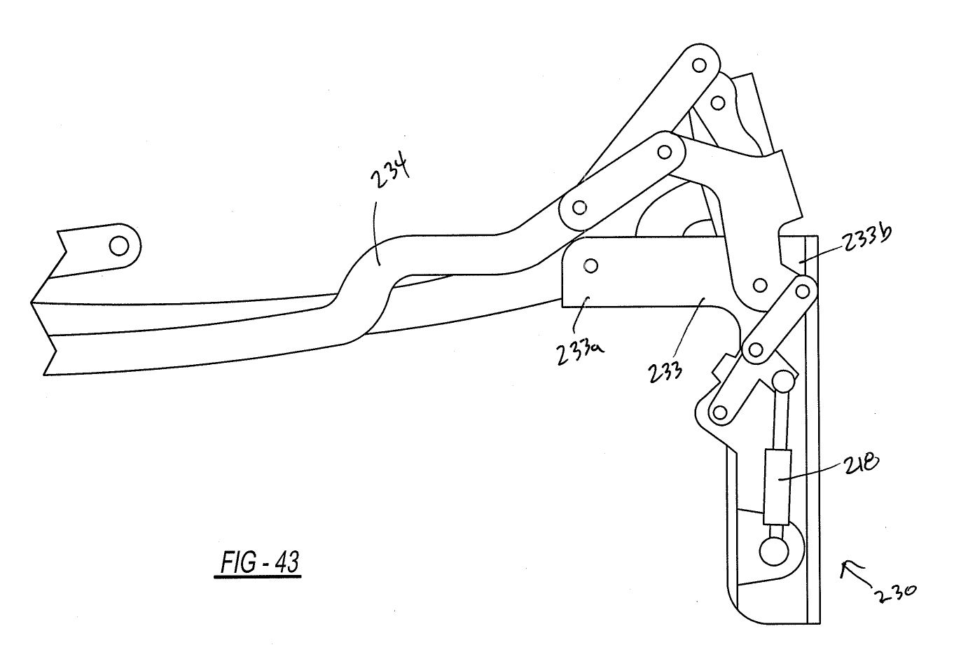

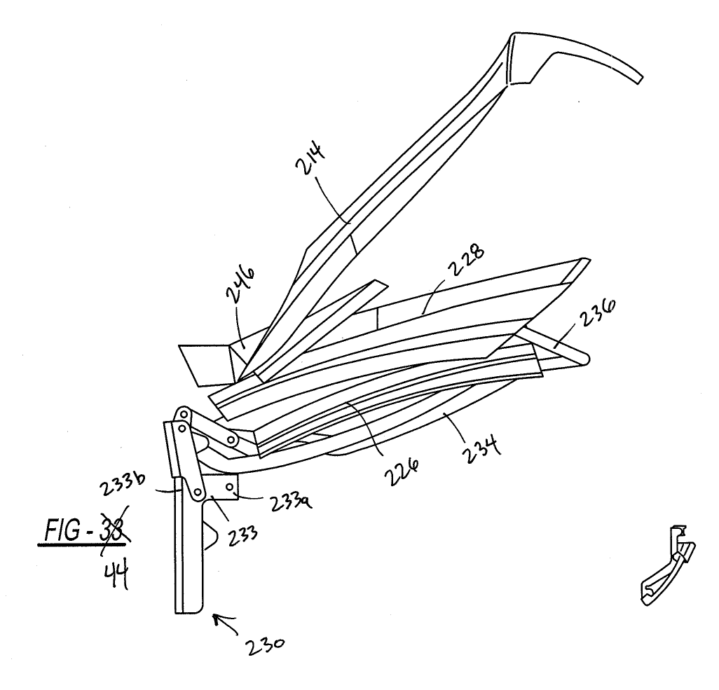

Referring now to FIGS. 34-44, the main pivot bracket 230 is shown. The main pivot bracket 230 includes a floating pivot point (third pivot axis) 238 that reduces the package space of the convertible top assembly 212, as shown in FIGS. 38 and 39. In operation, the floating pivot point 238 moves (rotates, pivots, etc.) from a first location (up position) 238a to a second location (down position) 238b during retraction of the convertible top 212 and in particular, during articulation of the front panel 226 via the front link 234, as shown in FIGS. 38 and 39. The front and rear link 234, 236 provide a compact design that occupies a relatively small amount of space, particularly when the top 212 is in the down position, as shown in FIG, 39. The main pivot bracket 230 is designed to have a linkage and hydraulic cylinder to facilitate opening and closing of the top 212 and provide for easier loading of the storage/trunk area 215 of the vehicle 210, as shown in FIGS. 40-44. For example, cargo (e.g., luggage, etc.) can be removed from or placed within the trunk/storage area 215 by pressing an actuator (not shown) that activates the mechanism to tilt the front and rear panels 226, 228 upward about their forward edges 226d, 228d so that the cargo can be removed from or placed within the trunk 215 without the need to completely cycle the top 212 to its closed position, as shown in FIG. 44.

Many modifications and variations of the present disclosure are possible in light of the above teachings. Therefore, within the scope of the appended claim, the present disclosure may be practiced other than as specifically described.

1-16. (canceled)

17. A convertible top assembly for a vehicle that is moveable between an extended position and a retracted position in a storage compartment of the vehicle, the assembly comprising:
a deck lid pivotable to provide access to the storage compartment;
a front panel member;
a rear panel member;
a main pivot bracket having a front link pivotally connected to a rear edge of the front panel member and a rear link pivotally attached to a rear edge of the rear panel member, such that an outer surface of the front panel member is adjacent an inner surface of the rear panel member and an inner surface of the deck lid is adjacent an outer surface of the rear panel member when the convertible top assembly is in the refracted position in the storage compartment.

18. The convertible top assembly of claim 17, wherein the main pivot bracket includes a base member fixedly attached to the vehicle.

19. The convertible top assembly of claim 18, wherein the base member includes a side member, and a lower end of the front link is pivotally secured to a forward end of the side member so that the front panel member pivots about a front panel pivot axis, and a lower end of the rear link is pivotally secured to a rearward end of the side member so that the rear panel member pivots about a rear panel pivot axis as the convertible top assembly is moved between the extended position and the retracted position.

20. The convertible top assembly of claim 19, wherein the rearmost edge of the rear panel member pivots about the rear panel pivot axis to a predetermined opening position prior to articulation of the front panel member about the front panel pivot axis.

21. The convertible top assembly of claim 20, further comprising a connecting link having a first end pivotally connected to the rear panel member and a second end pivotally connected to the deck lid, such that the outer surface of the rear panel member is adjacent the inner surface of the deck lid when the convertible top is in the retracted position in the storage compartment.

22. The convertible top assembly of claim 17, further comprising a tonneau cover pivotally connected to the main pivot bracket at a tonneau pivot axis, such that the front panel member passes over the tonneau cover and under the rear panel member when the convertible top assembly is moved to the refracted position.

23. The convertible top assembly of claim 17, further comprising a support device interconnecting the main pivot bracket to the forward link and the rearward link to facilitate movement of the front panel member and the rear panel member.

24. The convertible top assembly of claim 23, wherein the support device is a hydraulic cylinder.

25. The convertible top assembly of claim 17, further comprising an actuator for controlling movement of the main pivot bracket and thereby the front panel member and the rear panel member between the extended and the retracted position.

26. A method of retracting a convertible top for a vehicle, comprising:
pivoting a front edge of a deck lid upwardly along a deck lid pivot axis while pivoting a front edge of a rear panel upwardly about a rear panel pivot axis until the deck lid and rear panel attain a predetermined opening angle;
pivoting a front panel rearwardly along an arcuate path and about a front panel pivot axis, so that the front panel passes underneath the rear panel and is stowed in a storage compartment of the vehicle;
lowering the rear panel to stow the rear panel in the storage compartment to be adjacent the front panel; and
closing the deck lid over the storage compartment.

27. A method as set forth in claim 26 wherein pivoting a front panel further includes pivoting a tonneau cover upwardly about a tonneau cover pivot axis so that the front panel passes over the tonneau cover and under the rear panel.

28. The method as set forth in claim 27 wherein lowering the rear panel further includes closing the tonneau cover after the rear panel is lowered.

29. The method as set forth in claim 26 wherein the front panel and the real panel are interconnected via a main pivot bracket having a front link pivotally connected to a rear edge of the front panel and a rear link pivotally attached to a rear edge of the rear panel, such that an outer surface of the front panel is adjacent an inner surface of the rear panel when the convertible top is stowed in the storage compartment.

30. The method as set forth in claim 29 wherein the main pivot bracket includes a base member fixedly attached to the vehicle, and the base member includes a side member, and a lower end of the front link is pivotally secured to a forward end of the side member so that the front panel pivots at the front panel pivot axis, and a lower end of the rear link is pivotally secured to a rearward end of the side member at the rear panel pivot axis as the convertible top is moved between an extended position and a retracted position in the storage compartment.

31. A convertible top assembly for a vehicle that is moveable between an extended position and a retracted position in a storage compartment of the vehicle, the assembly comprising:
a deck lid pivotable to provide access to the storage compartment;
a front panel member;
a rear panel member;
a main pivot bracket having a forward link pivotally connected to a rear edge of the front panel member and a rearward link pivotally attached at a first end to the rear panel member and pivotally attached at a second end to the forward link, such that an outer surface of the front panel member is adjacent an inner surface of the rear panel member and an inner surface of the deck lid is adjacent an outer surface of the rear panel member when the convertible top assembly is in the retracted position in the storage compartment.
